(19) United States
(12) Patent Application Publication
(10) Pub. No.: US 2022/0415120 A1
(43) Pub. Date: Dec. 29, 2022

(54) SYSTEM AND METHOD FOR IDENTIFYING CHEATING AND MALFUNCTION OF ELECTRONIC CASINO GAMING MACHINES

(71) Applicant: Scott Melnick, Atlanta, GA (US)

(72) Inventor: Scott Melnick, Atlanta, GA (US)

(21) Appl. No.: 17/304,738

(22) Filed: Jun. 24, 2021

(51) Int. Cl. G07F 17/32

(52) U.S. Cl. CPC G07F 17/3241; G07F 17/3234; G07F 17/3239

(57) ABSTRACT

A system and method for monitoring electronic gaming machine play to determine outcome patterns indicative of cheating or malfunctioning of the electronic gaming machine. The system and method monitors, in substantially real time, an accounting system database associated with the subject electronic gaming machine and compares Par sheet data and theoretical outcomes for the subject gaming machine. In the event cheating is taking place or a malfunction has occurred, the system and method is configured to recognize the same, lock up the electronic gaming machine and/or notify casino personnel.

### FIELD OF THE INVENTION

The embodiments of the present invention relate to a system and method for identifying cheating and malfunctioning of electronic gaming machines such as slot machines.

### BACKGROUND

As gaming continues to expand in the United States and throughout the world, unscrupulous people and syndicates of such people are constantly working to defeat electronic gaming machines using improper and illegal methods. By way of example, in 2014, a team of Russian hackers were able to illegally beat Aristocrat slot machines.

Thus, it would be advantageous to develop a system and method for identifying electronic gaming machines being compromised or malfunctioning.

### SUMMARY

The embodiments of the present invention are directed to a system and method for monitoring electronic gaming machine play to determine outcome patterns indicative of cheating or malfunctioning of the electronic gaming machine. More particularly, the system and method monitors, in substantially real time, an accounting system database associated with the subject electronic gaming machine and compares par sheet data and theoretical outcomes for the subject gaming machine. In the event cheating is taking place or a malfunction has occurred, the system and method is configured to recognize the same, lock up the electronic gaming machine and notify casino personnel.

In one embodiment, the system comprises a network of electronic gaming machines in communication with an accounting system. The accounting system is in turn in communication with a software module of the embodiments of the present invention that monitors actual real-time gaming machine data against par sheet data and theoretical outcomes for the subject gaming machine. If the actual real-time data is determined to be unrealistic statistically (e.g., malfunction or cheating), the system notifies casino personnel.

Other variations, embodiments and features of the present invention will become evident from the following detailed description, drawings and claims.

### BRIEF DESCRIPTION OF THE DRAWINGS

FIG. 1 illustrates a block diagram of an electronic gaming machine of the type that may benefit from the embodiments of the present invention;

FIG. 2 illustrates a network of electronic gaming machines of the type that may benefit from the embodiments of the present invention;

FIG. 3 illustrates a back-end casino system of the type which may utilize the embodiments of the present invention;

FIGS. 4A and 4B illustrate block diagrams of an electronic gaming system architecture according to the embodiments of the present invention;

FIGS. 5A-5D illustrate exemplary par sheet data and related data associated with various slot machines;

FIG. 6 illustrates a flow chart of a methodology undertaken according to the embodiments of the present invention; and

FIG. 7 illustrates a block diagrams of a table gaming system architecture according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Java Script, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming device” should be understood to be any one of a general-purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

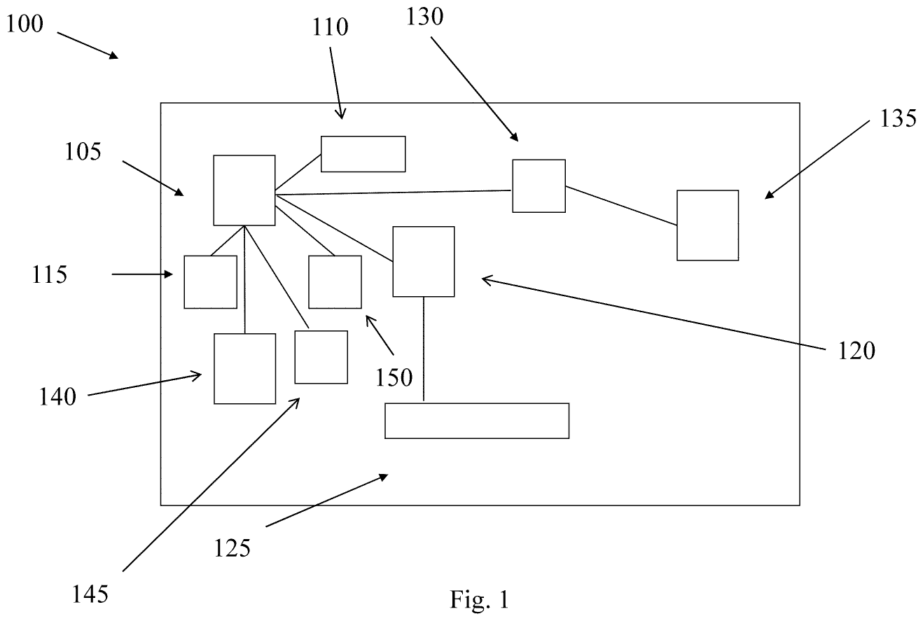

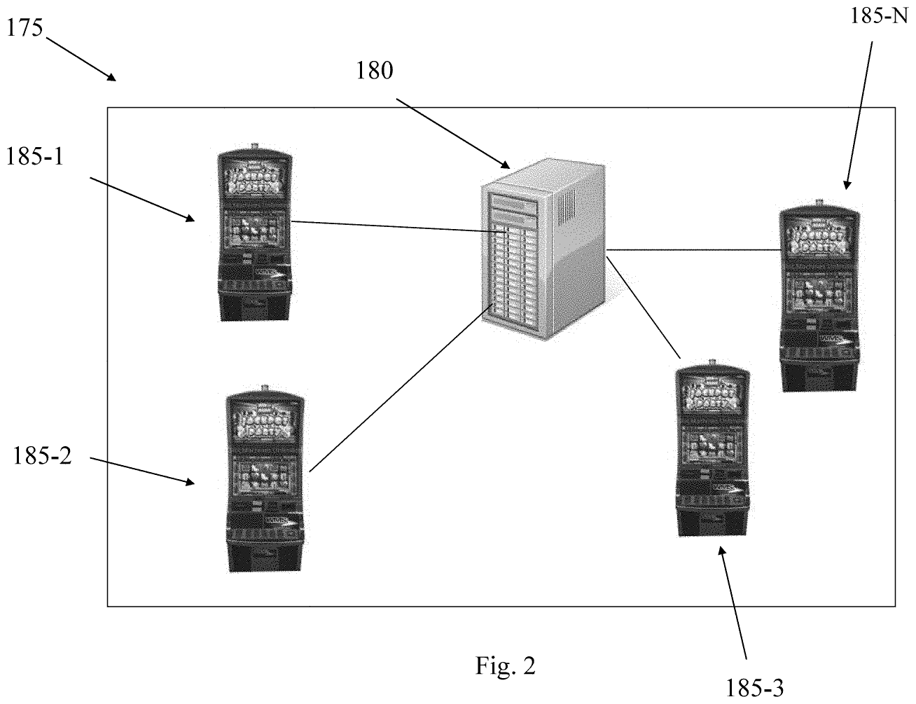

The embodiments of the present invention are facilitated by electronic gaming machines. A block diagram of an electronic gaming machine 100 is shown in FIG. 1. The exemplary class II electronic gaming machine 100 may include a central processing unit (CPU) also deemed a processor 105 which communicates with a central bingo server 200 (shown in FIG. 2) based on instructions stored in program read-only memory (ROM) 110 and pay table ROM 115. Program ROM 110 stores executable instructions related to the operation of the gaming machine 100 and which are generally permanent. Alternatively, one or more processors integrated into the central bingo server control the gaming machine 100 based on instructions stored in program ROM 110.

CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard.

A user interface 140 may respond to buttons on button panel or display incorporating touch screen technology or any other devices providing means for users to communicate with, and instruct, the electronic gaming machine 100. Wager memory 145 stores an amount of money/credits deposited into the electronic gaming machine 100 by a player and specific wager information related to each play of the electronic gaming machine 100. Payout system 150 may include a coupon printer or similar device for disseminating payout coupons from the electronic gaming machine 100.

Those skilled in the art will recognize that the configuration and features of the electronic gaming device 100 disclosed herein are exemplary and may be altered in any number of ways without impacting the embodiments of the present invention.

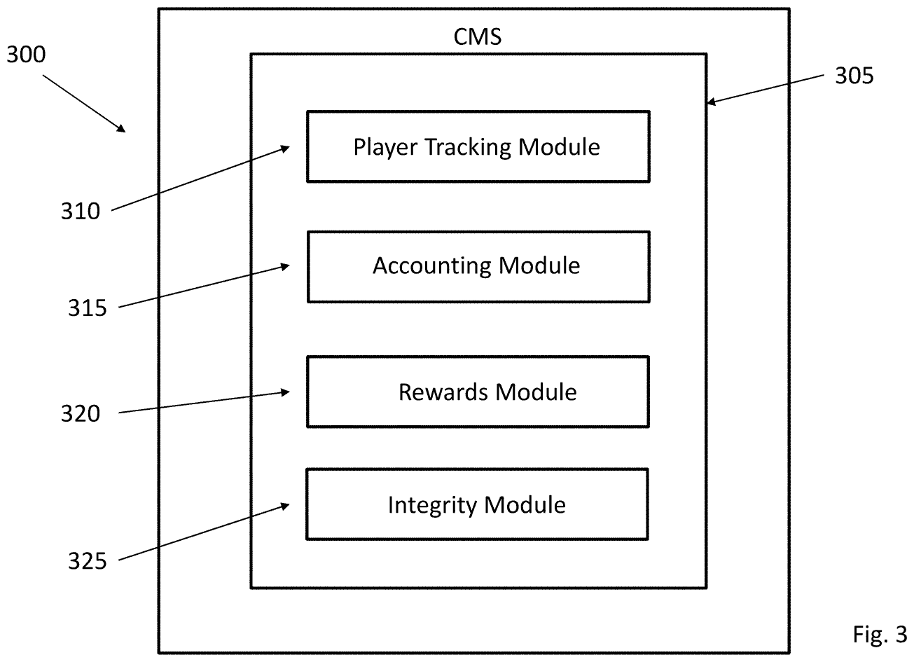

FIG. 2 shows a block diagram of a network 200 of electronic gaming machines of the type that may benefit from the embodiments of the present invention. The network 200 comprises a server 205, including one or more processors 210 running at least a casino management system, accounting system and player tracking system (as shown in FIG. 3), and electronic gaming machines 215-1 through 215-N configured to communicate with server 205.

FIG. 3 shows a back-end system comprising a server 300 maintaining a casino management system (CMS) 305 comprising at least a player tracking module 310, accounting module 315, rewards module 320 and integrity module 325. Those skilled in the art will recognize that other modules may be maintained/run by the server 300. The software modules may incorporate databases or be in communication with separate databases. In this instance, the integrity module 325 runs the software necessary to facilitate the embodiments of the present invention. It is understood that the integrity module 325 may be a separate module, as shown, or may be integrated into one of the other modules (e.g., accounting module 315). It is also understood that the integrity module 325 may be maintained in system other than the casino management system 305 and be maintained by a separate server.

In one embodiment, the accounting module 315 is a slot accounting system known as SAS in the casino industry. Those skilled in the art will recognize that other accounting systems and modules may be used. Despite the type of accounting module 315 being utilized, the accounting module 315 is configured to receive data from each electronic gaming machine on the network. For purposes of the embodiments of the present invention, real time play data related to cash-in amounts, cash-out amounts, bets placed, winnings paid out and the time associated with each action, on each networked electronic gaming machine is sent or otherwise made available to the integrity module 320 by the accounting module 315 or may be received directly from each networked electronic gaming machine.

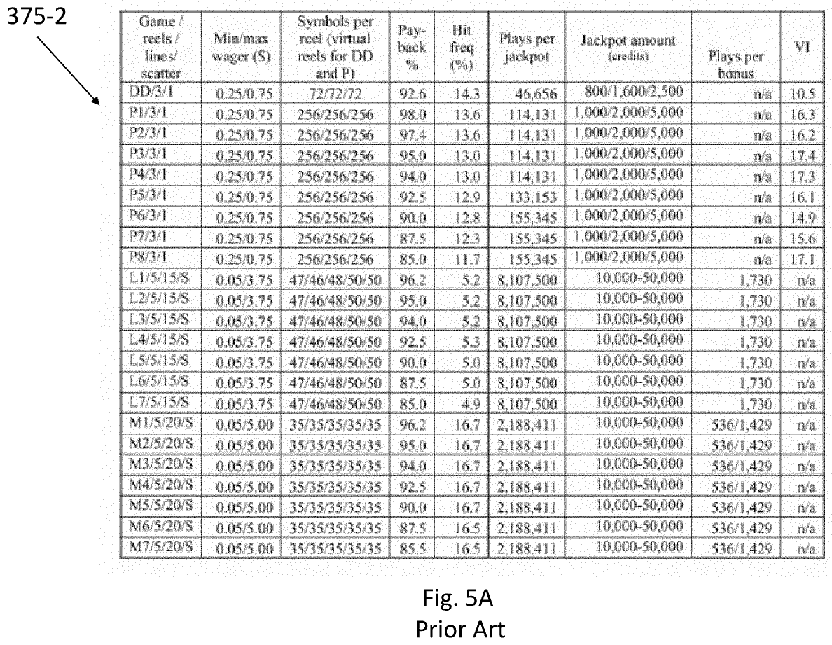

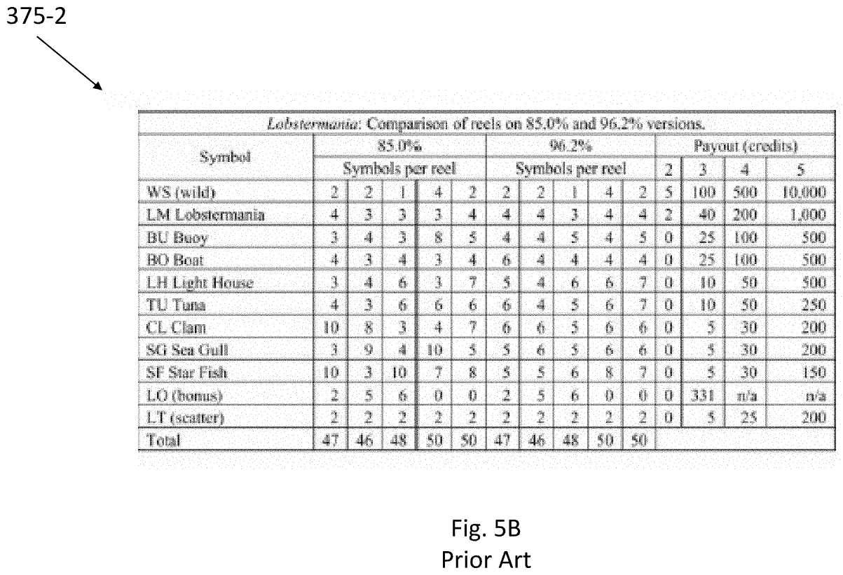

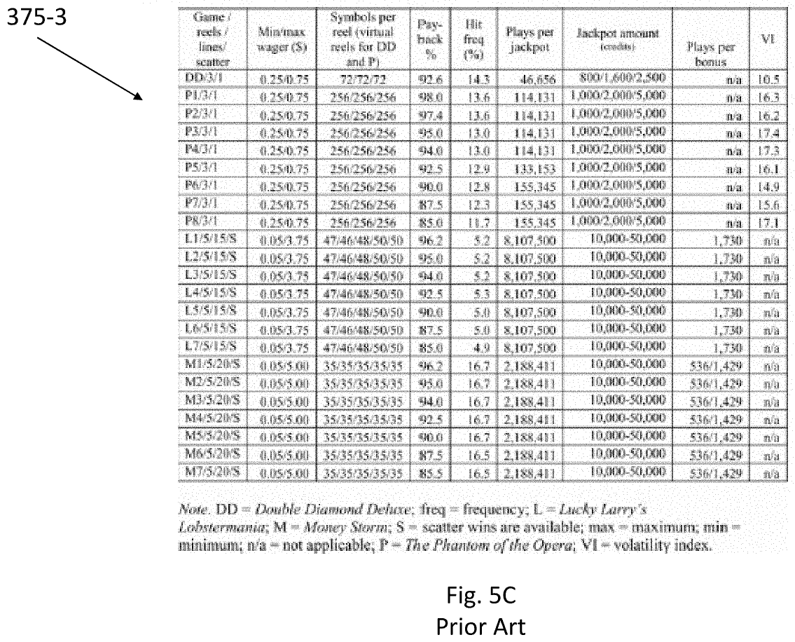

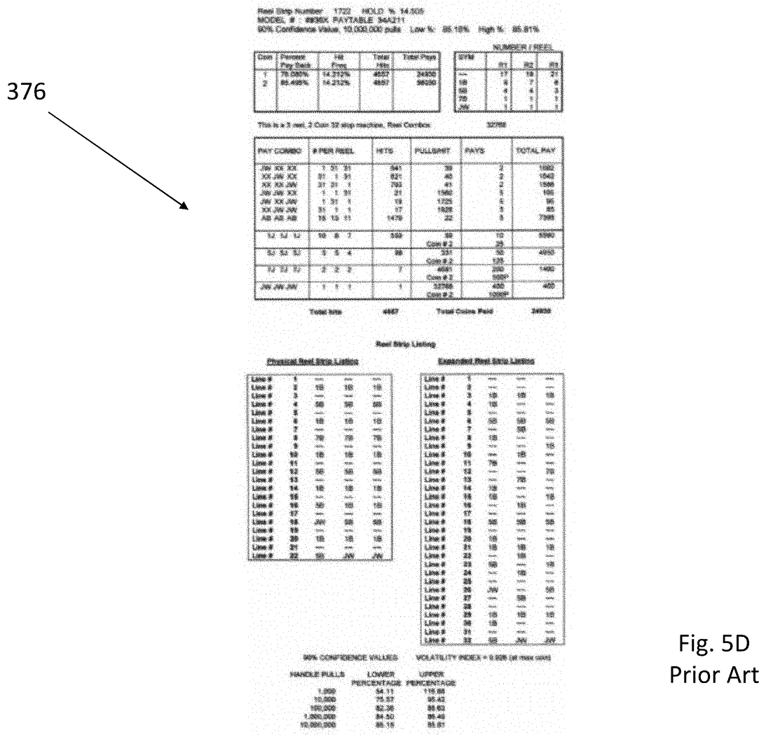

The integrity module 320 is first configured to monitor real time play data transmitted by the networked electronic gaming machines to the accounting module 315 or directly to the integrity module 320. In either instance, the integrity module 320 compares the real time play data with the Par sheet and theoretical outcomes of the particular game being played. FIGS. 5A-5D show exemplary data tables 375-1 through 375-3 and Par sheet 376 and of the type that are utilized by the integrity modules 320.

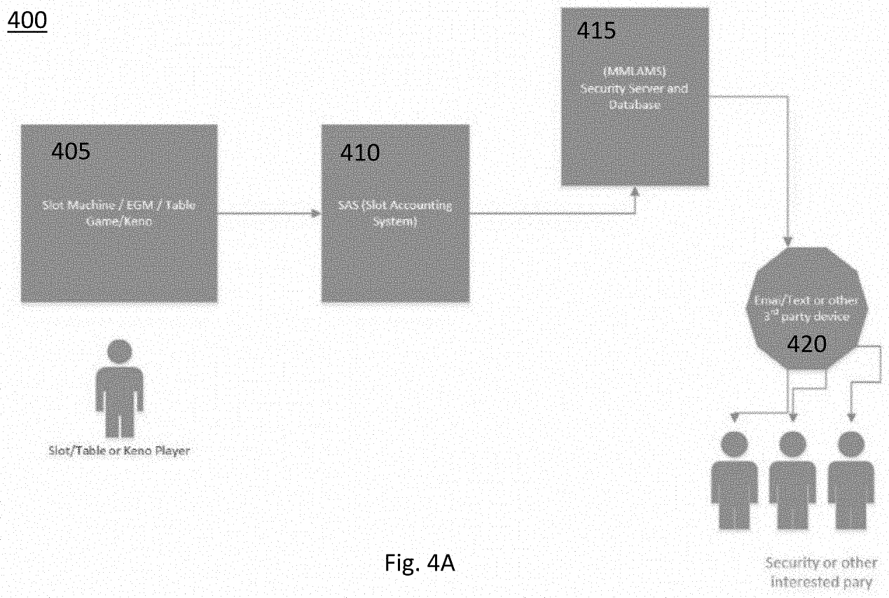

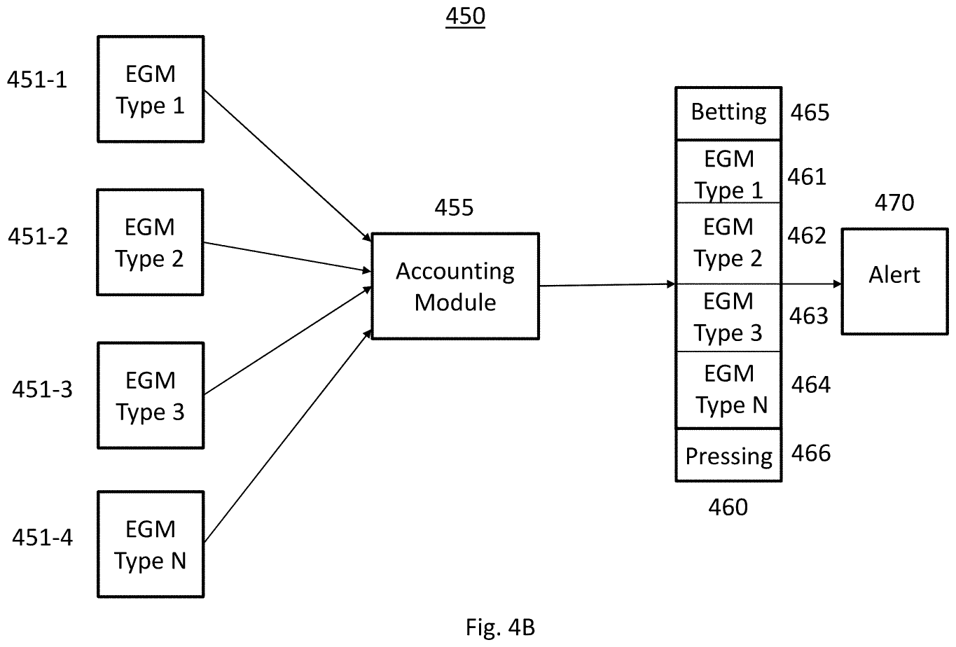

FIG. 4A shows a basic network architecture 400 comprising a plurality of electronic gaming machines 405, accounting module 410, integrity module 415 and notification dissemination 420. FIG. 4B shows a more detailed network architecture 450. In a typical casino setting, there are many types and brands of electronic gaming machines of the floor. FIG. 4B shows EGM Type 1 451-1, EGM Type 2 451-2, EGM Type 3 451-3 through EGM Type N 451-4. Each EGM is categorized by type based on its Par sheet data and related data. As the electronic gaming machines are played, they send the real time play data to the accounting module 455 which transmits the data to the integrity module 460 (the electronic gaming machines may also send the data directly to the integrity module 460). Once received by the integrity module 460, the data is compared to the stored data in the corresponding database comprising EGM Type 1 database 461, EGM Type 2 database 462, EGM Type 3 database 463 and EGM Type N database 464.

In one embodiment, the integrity module 460 is further configured to receive and analyze betting and button pressing patterns relative to wins. In such an embodiment, the integrity module 460 includes a betting sub module 465 and button pressing sub module 466 which compare previous betting and button pressing patterns (received from the electronic gaming machines) associated with winning outcomes and determines if the player has found a way to beat the electronic gaming machine through weaknesses in the software, cheating by the player or other anomalies. Button pressing patterns may include the order of the button presses as well as the timing thereof. It is known as “gaffing” for a player to press a sequence of buttons or undertake a sequence of actions in order to beat an electronic gaming machine. By way of example, if a player inserts $5, $10, $1, $5 and $20 consecutively and wins a meaningful or threshold award, the integrity module 460 stores the betting pattern for future comparison to identify a malfunction, cheating scheme (e.g., figuring out the operation of the random number generator) or other anomaly. The same applies to the timing pattern between successive button presses (e.g., 2 secs, 4 secs and 6 secs). If integrity module 460 identifies a malfunction, cheating scheme or other suspicious behavior, an alert 470 is sent to casino personnel.

In another embodiment, the integrity module 460 is further configured to receive and analyze the time of button pressing relative to wins. Rather than evaluating the timing between button presses, the integrity module 460 evaluates the actual time of day the buttons are pressed seeking patterns. For example, if a play button is pressed at the same time every day for successive days before a large win, the system tags it as a possible malfunction, anomaly or cheating scheme.

While the disclosure above details button pressing, in other embodiments, the system evaluates wins against patterns associated with gaming machine peripherals, such as bill validators, printers, card readers, joysticks, motion detectors and similar. Relative to internet-based games, the system evaluates generated network traffic between the gaming machine and the server for malfunctions, anomalies and cheating schemes.

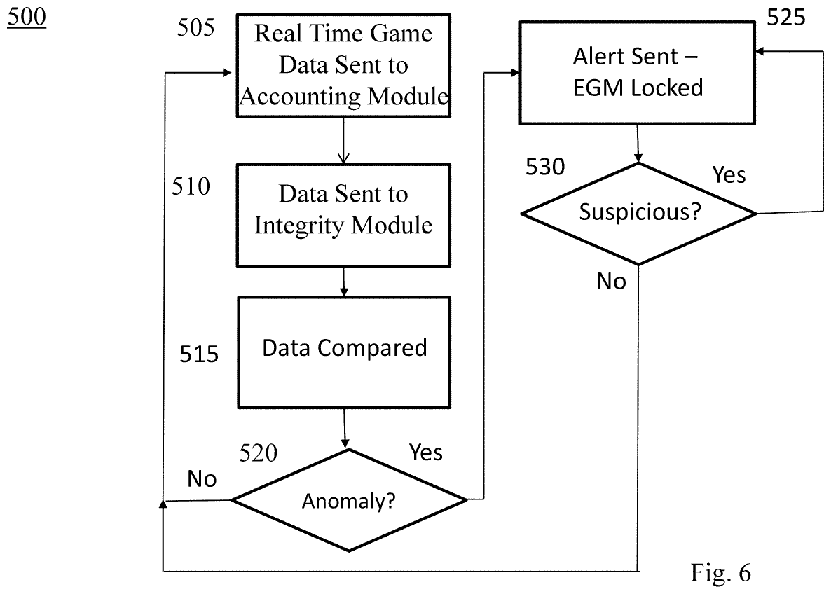

FIG. 6 shows a flow chart 500 detailing one methodology followed by the system for electronic of the embodiments of the present invention. At 505, real time game data from electronic gaming machines, such as slot machines, keno machines, video poker machines, etc., are sent to an accounting module (or integrity module). At 510, the data are sent to the integrity module. At 515, the data are analyzed within segregated databases associated with each type of electronic gaming machine. That is, all Type 1 electronic gaming machines are analyzed by a corresponding database based on the known parameters (i.e., Par sheet data) of Type 1 electronic gaming machine, all Type 2 electronic gaming machines are analyzed by a corresponding database based on the known parameters of Type 2 electronic gaming machine and so on. If, at 520, an anomaly is identified, at 525, an alert is sent to casino personnel and, optionally, the electronic gaming machine is locked. Alerts may be sent via email, SMS or other media. Optionally, at 530, it is determined if any other suspicious behavior (e.g., betting patterns or button pressing patterns) has taken place. If so, at 525, an alert is sent to casino personnel and, optionally, the electronic gaming machine is locked.

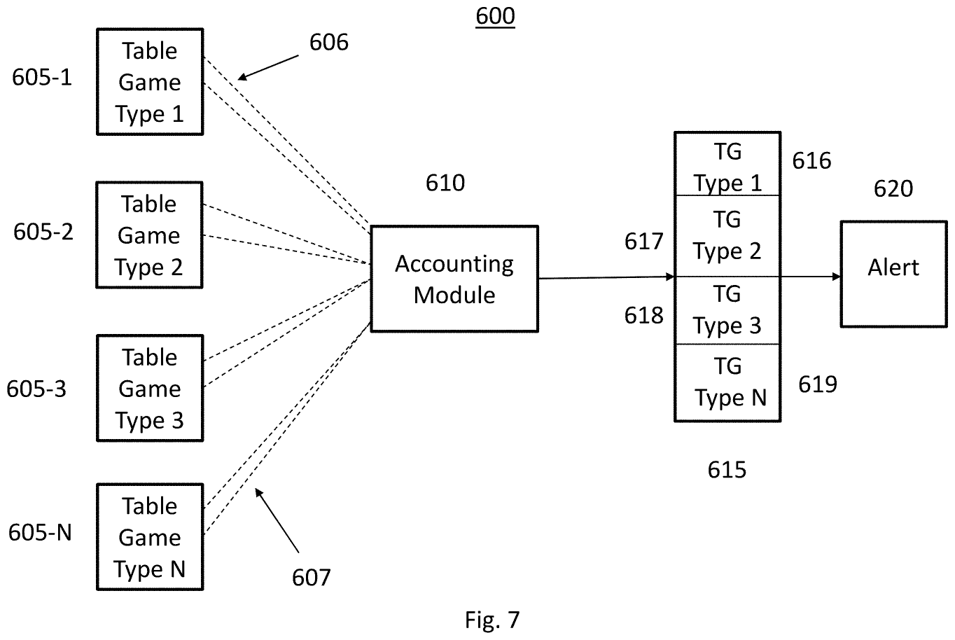

The technology detailed above may also be adapted to table game betting patterns and winning outcomes. In this embodiment, as known in the art, table game betting is tracked via RFID gaming chips or similar NFC technology in combination with the hands dealt as tracked by automatic card shufflers. For example, card counting in Blackjack is a well-known method for beating the game of Blackjack. While card counting is not illegal, most casinos ban the practice. The most effective way of spotting a Blackjack card counter is by monitoring his or her betting patterns. When the blackjack count is advantageous to the house, the player bets small and when the blackjack count turns advantageous to the player, the player bets larger. The system detailed herein can identify such card counting as shown in FIG. 7. The system may also evaluate whether a certain seat position at a gaming table is receiving a favorable number (i.e., more than theoretically likely) of good hands.

FIG. 7 shows a basic network architecture 600 comprising a plurality of table games of similar types (e.g., Blackjack) 605-1 through 605-N. Each table game incorporates gaming chips using RFID technology for tracking movements of the same and includes automatic card shufflers configured to track the cards dealt and the outcomes of the respective hands. In one embodiment, gaming chip data including bets made, bets won and loss, as well as each hand associated therewith is transmitted to the accounting module 610 via signal 606 emanating the RFID technology and the cards dealt data is transmitted via the automatic card shufflers to the accounting module 610 via signal 607 emanating from the automatic card shuffler (the data may also be transmitted directly to the integrity module 615). The signals may travel via wire or wirelessly. The accounting module 610 then transmits the data to the integrity module 615. Once received by the integrity module 615, the data is analyzed within the corresponding database comprising TG Type 1 database 616, TG Type 2 database 617, TG Type 3 database 618 and TG Type N database 619. If betting anomalies are uncovered, alerts 620 are sent out.

The embodiments of the present invention may be utilized with any and all types of gaming machines including standalone gaming machines, bar top gaming machines, networked gaming machines, server-based gaming machines, internet-based gaming machines and internet-based gaming played via laptops, desktops and mobile devices. Moreover, the system may be used with standalone gaming machines not utilizing a central server, small, localized gaming systems (e.g., bars and taverns), and gaming machines and networks thereof not having a backend SAS. As set forth above, the system is also suitable for table games, number-based games, such as lottery games, pulltab, Keno, etc., in electronic or physical form.

Although the invention has been described in detail with reference to several embodiments, additional variations and modifications exist within the scope and spirit of the invention as described and defined in the following claims.

I claim:

1. A computer-implemented system comprising:
at least one processor running executable instructions to:
receive substantially real time gaming data from one or more electronic gaming machines;
compare said substantially real time gaming data to theoretical data associated with said one or more electronic gaming machines to identify a malfunction, cheating or anomaly associated with said real time gaming data; and
responsive to an identification of a malfunction, cheating or anomaly has occurred, transmit an alert to casino personnel.

2. The computer-implemented system of claim 1 further comprising said at least one processor running executable instructions to: analyze real time betting patterns, button pressing patterns, time of day patterns and peripheral usage patterns.

3. The computer-implemented system of claim 1 further comprising said at least one processor running executable instructions to: analyze generated network traffic between the gaming machine and a server.

4. The computer-implemented system of claim 1 further comprising said at least one processor running executable instructions to: lock any said electronic gaming machine associated with a malfunction, cheating or anomaly.

5. The computer-implemented system of claim 1 further comprising said at least one processor running executable instructions to: transmit an alert responsive to a malfunction, cheating or anomaly.

6. The computer-implemented system of claim 1 wherein the one or more electronic gaming machines include standalone gaming machines, bar top gaming machines, networked gaming machines, server-based gaming machines and internet-based gaming machines.

7. The computer-implemented system of claim 1 wherein the theoretical data is derived from par data sheets associated with said one or more electronic gaming machines.

8. A computer-implemented system comprising:
at least one processor running executable instructions to:
receive substantially real time betting data and hand data from one or more casino table games;
analyze said substantially real time betting data and hand data to identify cheating or card counting associated with said real time betting data and hand data; and
responsive to an identification of cheating or card counting, transmit an alert to casino personnel.

9. The computer implemented system of claim 8 further comprising gaming chips utilizing RFID technology.

10. The computer implemented system of claim 9 wherein said RFID technology acquires said real time betting data from one or more casino table games.

11. The computer implemented system of claim 8 further comprising automatic card shufflers configured to track cards and hands dealt.

12. The computer implemented system of claim 11 further comprising tracking favorable hands in conjunction with seat positions.

13. The computer implemented system of claim 11 wherein said automatic card shufflers acquire said hand data from one or more casino table games.

14. A computer-implemented method comprising:
via at least one processor:
receiving substantially real time gaming data from one or more electronic gaming machines;
comparing said substantially real time gaming data to theoretical data associated with said one or more electronic gaming machines to identify a malfunction, cheating or anomaly associated with said real time gaming data malfunction, cheating or anomaly; and
responsive to an identification of that a malfunction, cheating or anomaly has occurred, transmit an alert to casino personnel.

15. The computer-implemented method of claim 14 further comprising via at least one processor:
analyzing real time betting patterns, button pressing patterns, time of day patterns and peripheral usage patterns.

16. The computer-implemented method of claim 14 further comprising via at least one processor:
analyzing generated network traffic between the gaming machine and a server.

17. The computer-implemented method of claim 14 further comprising via at least one processor:
locking any said electronic gaming machine associated with a malfunction, cheating or anomaly.

18. The computer-implemented method of claim 14 further comprising via at least one processor:
transmitting an alert responsive to a malfunction, cheating or anomaly.

19. The computer-implemented method of claim 14 wherein said one or more electronic gaming machines include standalone gaming machines, bar top gaming machines, networked gaming machines, server-based gaming machines and internet-based gaming machines.

20. The computer-implemented method of claim 14 further comprising utilizing theoretical data derived from par data sheets associated with said one or more electronic gaming machines.
